(19) United States
(12) Patent Application Publication
(10) Pub. No.: US 2026/0286550 A1
(43) Pub. Date: Sep. 24, 2026

(54) PROCESS FOR MANUFACTURING AT LEAST ONE PORTION OF AN ELECTROLYTIC CELL, CORRESPONDING ELECTROLYTIC CELL PORTION AND ELECTROLYZER STACK

(71) Applicant: JOHN COCKERILL HYDROGEN BELGIUM, Seraing (BE)

(72) Inventor: Marc Nouaille-Degorce, Seraing (BE)

(73) Assignee: JOHN COCKERILL HYDROGEN BELGIUM, Seraing (BE)

(21) Appl. No.: 19/478,434

(22) PCT Filed: Apr. 24, 2024
(86) PCT No.: PCT/EP2024/061248

§ 371 Date: Oct. 24, 2025

(30) Foreign Application Priority Data
Apr. 28, 2023 (BE) 2023/5348

(51) Int. Cl. C25B 11/036; C25B 1/04; C25B 9/19; C25B 9/77; C25B 11/046

(52) U.S. Cl. CPC C25B 11/036; C25B 9/19; C25B 9/77; C25B 11/046; C25B 1/04

(57) ABSTRACT

A process for manufacturing at least one portion of an electrolytic is provided. The process includes at least the step of printing at least one layer (3) on a first face of a bipolar plate (1) by additive manufacturing, a first face (4a) of the layer (3) being secured to the first face of the bipolar plate and the second face (4b) of the layer (3) forming at least one free end, the layer being formed of a mesh forming a cellular structure. Also disclosed are a corresponding portion of an electrolytic cell and a corresponding electrolyzer stack.

The invention relates to a method for manufacturing at least a part of an electrolytic cell.

The invention also relates to a part of an electrolytic cell, which is manufactured by such a method.

The invention also relates to an electrolyzer stack comprising such an electrolytic cell.

### BACKGROUND OF THE INVENTION

The overall architecture of an electrolyzer stack usually consists of a block of electrolytic cells, which are stacked in series electrically and in parallel fluidically, and gaskets.

The purpose of each electrolytic cell is to promote the electrolysis of an electrolytic solution (alkaline water, pure water, unpurified water, salt, aqueous chloride solution, aqueous bromide solution, aqueous hydrochloric acid solution, etc.).

For example, the functionality of an electrolyzer stack is to promote the reaction producing gaseous dihydrogen (H₂) and dioxygen (O₂) as a result of the dissociation of water after having injected a direct electric current into an alkaline solution, generally potassium hydroxide (KOH) or sodium hydroxide (NaOH).

Each electrolytic cell, considered as an article that is mainly metallic and conductive (although some parts of it may be nonmetallic), is generally composed of two bipolar plates framing two flow field materials, which themselves frame two electrodes, generally in the form of metallic plates or meshes or cloths. In the case of an alkaline electrolyzer stack, said electrodes are generally made of nickel. The two electrodes (a cathode and an anode) are separated by a membrane (also referred to as a diaphragm or porous separator in the case of an alkaline electrolyzer stack) which ensures the electrical isolation between the two electrodes, the separation of the gases as well as the ionic conduction within the electrolytic cell.

The flow field material has two functionalities: i) providing a metallic path with low resistivity between each bipolar plate and the associated electrode, and ii) allowing suitable flow of the electrolytic solution in order to cool the electrolyzer stack and transport the gases generated.

The name bipolar plate derives from the fact that, since the electrolytic cells are all contiguous with one another, a bipolar plate N will be at a potential:
higher than the downstream bipolar plate N+1, so that the bipolar plate N will act as the anode within an electrolytic cell defined by the bipolar plates N and N+1;
lower than the upstream bipolar plate N−1, so that the bipolar plate N will act as the cathode within an electrolytic cell defined by the bipolar plates N−1 and N.

Numbered among the other metallic articles, in addition to the bipolar plates, are the distribution plates (which enable the electrical supply and distribution of the electrolytic cells) as well as the base plates (for delimiting the group of electrolytic cells and clamping said electrolytic cells to one another, as well as sealing them).

Specifically, the electrolyzer stack ends with two base plates situated just before the first stacked electrolytic cell and just after the last stacked electrolytic cell, which is to say one base plate is located upstream of the block of electrolytic cells and the other base plate is placed downstream thereof, with a view to physically delimiting the two ends of said block of electrolytic cells.

An electrolyzer stack therefore proves relatively onerous to manufacture.

### OBJECT OF THE INVENTION

It is an object of the invention to propose a solution for manufacturing an electrolyzer stack more easily.

### SUMMARY OF THE INVENTION

For this purpose, the invention provides a method for manufacturing at least a part of an electrolytic cell, the method comprising at least the step of printing at least one layer on a first face of a bipolar plate by additive manufacturing, of which layer a first face is secured to the first face of the bipolar plate and the second face forms at least one free end, the layer being formed by a mesh describing a cellular structure, the contact between the first face and the first main face being formed by a plurality of point contacts between said layer and the first main face.

In this way, the plate thus manufactured comprises a layer that acts both as a flow field material of the prior art (because of the mesh) and an electrode of the prior art (because of the at least one free end of the mesh).

Therefore, the manufacture and particularly the mounting of an electrolyzer stack comprising such a plate are thereby greatly facilitated.

Optionally, the bipolar plate is also manufactured by an additive method.

Optionally, the layer and/or the bipolar plate is printed from a nickel-based material.

Optionally, the layer is a first layer, the method comprising the step of printing at least one second layer on a second face of the bipolar plate by additive manufacturing, of which layer a first face is secured to the second face of the bipolar plate and the second face forms at least one free end, the second layer being formed by a mesh describing a cellular structure.

Optionally, the first layer has the same shape as the second layer.

Optionally, the second layer consists of the same material as the first layer.

Optionally, the two layers are printed at the same time.

Optionally, the bipolar plate is a first bipolar plate, the method comprising the step of printing at least one layer on a first face of a second bipolar plate by additive manufacturing, of which layer a first face is secured to the first face of the bipolar plate and the second face forms at least one free end, the layer being formed by a mesh describing a cellular structure.

Optionally, the two bipolar plates are contiguous while being separated by a membrane, so that the second faces of the layers of the two bipolar plates both lie next to the membrane.

The invention also relates to a part of an electrolytic cell, which part is manufactured by a method as described above.

The invention also relates to an electrolyzer stack comprising a cell part as described above.

Other characteristics and advantages of the invention will become apparent when reading the following description of a particular nonlimiting embodiment of the invention.

### BRIEF DESCRIPTION OF THE DRAWINGS

Reference will be made to the appended drawings, in which:

FIG. 1 is a diagram illustrating various manufacturing steps of a part of an electrolytic cell according to one particular embodiment of the invention,

FIG. 2 schematically represents a portion of an electrolyzer stack incorporating the cell part, the manufacture of which is illustrated in FIG. 1,

FIG. 3 schematically represents a variant of the electrolyzer stack part illustrated in FIG. 2.

### DETAILED DESCRIPTION OF THE INVENTION

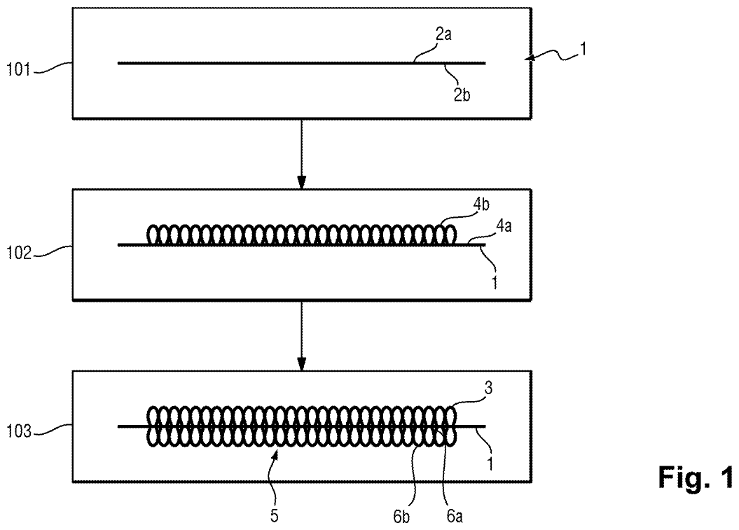

Referring to FIG. 1, a particular embodiment of a method for manufacturing at least a part of an electrolytic cell for an electrolyzer stack will be described.

During a first step 101, a bipolar plate 1 is selected.

The bipolar plate 1 is, for example, a bipolar plate that has already been manufactured by manufacturing methods of the prior art, for example bipolar plate manufactured by the present Applicant.

The bipolar plate 1 consists of a material that is capable of enduring the corrosive environment prevailing inside the electrolytic cell.

The bipolar plate 1 is for example based on nickel, and is for example made of nickel or nickel-alloyed carbon steel.

The bipolar plate 1 is furthermore configured so as to have a first main face 2a and a second main face 2b.

During a second step 102, a first layer 3 is printed on the first main face 2a by additive manufacturing, the layer having a first face 4a (i.e. the first coat printed on the first main face 2a) and a second face 4b (i.e. the last printed coat of the first layer 3).

The first layer 3 preferably consists of one single material.

Preferably, the first layer 3 consists of the same material as the bipolar plate 1.

For example, the first layer 3 is based on nickel, and is for example made of nickel or nickel-alloyed carbon steel.

The first layer 3 is formed by a mesh describing a cellular structure.

For example, the first layer 3 describes at least one plurality of loops. For at least one loop, for example, the lowest point of the loop is the only point of the loop in contact with the first main face 2a.

Since its first face 4a is printed directly on the first main face 2a, the first layer 3 is thus secured to the first main face 2a.

It is to be noted that because of the cellular structure of the first layer 3, the contact between the first face 4a and the first main face 2a is not a plane/plane contact over the entire surface of the first main face 2a. It is to be noted that because of the cellular structure of the first layer 3, the contact between the first face 4a and the first main face 2a is not a plurality of linear contacts either. In fact, the contact between the first face 4a and the first main face 2a is formed by a plurality of point contacts between the first layer 3 and the first main face 2a. In fact, the contact between the first face 4a and the first main face 2a is formed only by a plurality of point contacts between the first layer 3 and the first main face 2a. There is thus neither surface contact nor linear contact between the first layer 3 and the first main face 2a.

This allows the first layer 3 to reproduce well the role of a flow field material of the prior art.

The first layer 3 thus has two functionalities:
providing a metallic path with low resistivity between the bipolar plate 1 and its second face 4b,
allowing suitable flow of the electrolytic solution in order to cool the electrolyzer stack and transport the gases generated.

The second face 4b of the first layer 3 forms at least one free end. It is to be noted that because of the cellular structure of the first layer 3, there are in fact a plurality of free ends of the first layer 3.

This will allow the first layer 3 to better reproduce the role of an electrode of the prior art.

Preferably, during a third step 103, a second layer 5 is also printed on the second main face 2b by additive manufacturing, the layer having a first face 6a (i.e. the first coat printed on the second main face 2b) and a second face 6b (i.e. the last printed coat of the second layer 5).

This third step 103 may be carried out simultaneously with the second step 102 or after the second step 102.

The second layer 5 preferably consists of one single material.

The second layer 5 is formed from the same material as the first layer 3 or a different material.

Preferably, the second layer 5 consists of the same material as the bipolar plate 1.

For example, the second layer 5 is based on nickel, and is for example made of nickel or nickel-alloyed carbon steel.

The second layer 5 is formed by a mesh describing a cellular structure.

For example, the second layer 5 describes at least one plurality of loops. For at least one loop, for example, the lowest point of the loop is the only point of the loop in contact with the second main face 2b.

Since its first face 6a is printed directly on the second main face 2b, the second layer 5 is thus secured to the second main face 2b.

It is to be noted that because of its cellular structure of the second layer 5, the contact between the first face 6a and the second main face 2b is not a plane/plane contact over the entire surface of the second main face 2b. It is to be noted that because of the cellular structure of the second layer 5, the contact between the first face 6a and the second main face 2b is not a plurality of linear contacts either. In fact, the contact between the first face 6a and the second main face 2b is formed by a plurality of point contacts between the second layer 5 and the second main face 2b. In fact, the contact between the first face 6a and the second main face 2b is formed only by a plurality of point contacts between the second layer 5 and the second main face 2b. There is thus neither surface contact nor linear contact between the second layer 5 and the second main face 2b.

This allows the second layer 5 to reproduce well the role of a flow field material of the prior art.

The second layer 5 thus has two functionalities: providing a metallic path with low resistivity between the bipolar plate 1 and its second face 6b, allowing suitable flow of the electrolytic solution in order to cool the electrolyzer stack and transport the gases generated.

The second face 6b of the second layer 5 forms at least one free end. It is to be noted that because of the cellular structure of the second layer 5, there are in fact a plurality of free ends of the second layer 5.

This will allow the second layer 5 to better reproduce the role of an electrode of the prior art.

Optionally, the second layer 5 is identical to the first layer 3 in shape and/or material.

Thus, at the end of these three steps, an assembly 7 consisting of a bipolar plate 1 and two layers 3 and 5, which are secured to one another, is obtained.

This assembly 7 can act simultaneously as a bipolar plate as well as a flow field material and an electrode for a first electrolytic cell 9 (through the first layer 3) and as a bipolar plate as well as a flow field material and an electrode for a second electrolytic cell 10 (through its second layer 5), the second electrolytic cell 10 being directly adjacent to the first electrolytic cell 9.

The assembly 7 therefore makes it possible to act as an anode or a cathode for the first electrolytic cell 9 and as a cathode (or respectively an anode) for the second electrolytic cell 10.

Such an assembly 7 furthermore makes it possible to optimize the electrolysis inside the first electrolytic cell 9 and the second electrolytic cell 10, particularly because of the uniformity of the structure of said assembly 7. The assembly 7 proves in particular to be uniform between the interior of each layer 3, 5 (acting as the flow field material) and the corresponding second face 4b, 6b (acting as the electrode): this is because there is no junction between these two sublayers since everything is printed at the same time.

Therefore, the manufacture of an electrolyzer stack comprising such an assembly 7 is simplified, particularly in terms of assembling.

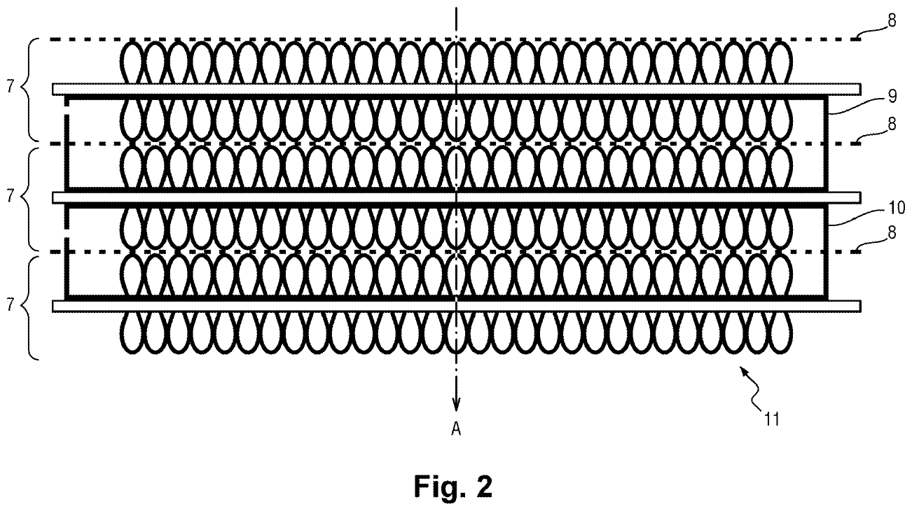

Referring to FIG. 2, it is actually possible to juxtapose a plurality of assemblies 7 as mentioned above while separating them in pairs by membranes 8 in order to form a complete electrolytic cell.

It is then to be noted that because of their cellular structures, the contact between the membrane 8 and each of the second faces 4b, 6b of the layers 3, 5 in contact with it is not a plane/plane contact over the entire surface of the membrane 8. It is to be noted that because of the cellular structure of the second layer 5 and of the first layer 3, the contacts between the membrane 8 and each of the second faces 4b, 6b of the layers 3, 5 is not a plurality of linear contacts either. In fact, the contact between the membrane 8 and each of the second faces 4b, 6b of said layers is formed by a plurality of point contacts (the free ends of the layers 3, 5) between the layer 3, 5 in question and the membrane 8. In fact, the contact between the membrane 8 and each of the second faces 4b, 6b of said layers is formed only by a plurality of point contacts (the free ends of the layers 3, 5) between the layer 3, 5 in question and the membrane 8. There is thus neither surface contact nor linear contact between the membrane 8 and the layers 3, 5.

For example, if the second layer 5 describes at least one plurality of loops, then for at least one loop the highest point of the loop is the only point of the loop in contact with the membrane 8.

For example, if the third layer 3 describes at least one plurality of loops, then for at least one loop the highest point of the loop is the only point of the loop in contact with the membrane 8.

By juxtaposing a first assembly 7, a first membrane 8, a second assembly 7, a second membrane 8, etc. in this way, it is possible to create a block 11 of electrolytic cells extending longitudinally along a general direction A. Said block 11 of electrolytic cells may then be used in a standard electrolyzer stack (replacing some or all of the block of electrolytic cells of the prior art).

The block 11 of electrolytic cells defined in this way extends longitudinally along the general direction A (the main faces of at least one of the bipolar plates 1 extending in planes normal to the general direction A).

FIG. 2 represents one possible application of this block 11 of electrolytic cells, in which the general direction A extends vertically.

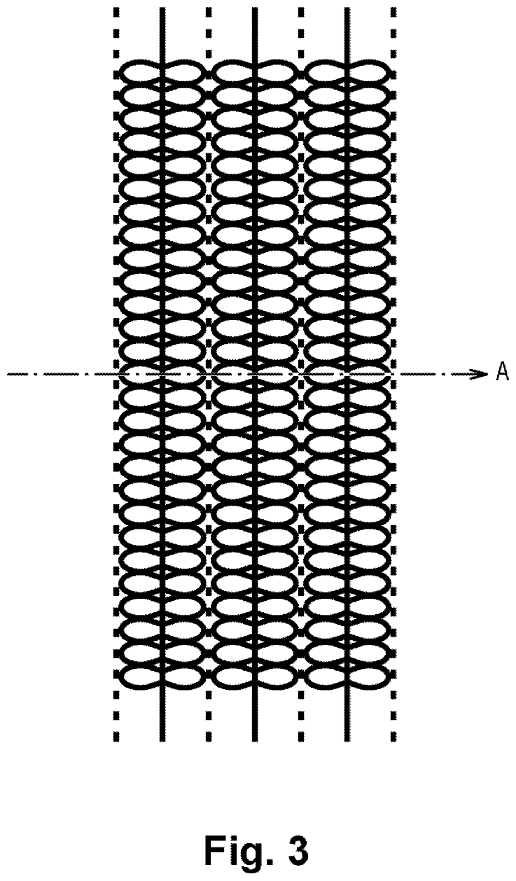

This application is of course not limiting, and the block 11 of electrolytic cells may thus be employed so that the general direction A extends horizontally, as represented in FIG. 3.

Moreover, in a first possibility, the first layer 3 and/or the second layer 5 is configured so that its mesh is similar or identical to that of a flow field material of the prior art and/or so that the free ends of the mesh are similar or identical to the zones of contact of an electrode of the prior art with the membrane 8. The mesh of the first layer 3 and/or of the second layer 5 may thus be regular (as is the case of the flow field materials of the prior art).

In a second possibility, the first layer 3 and/or the second layer 5 is configured in a different way than a mesh of a flow field material of the prior art and/or the free ends of the mesh are configured in a different way than the zones of contact of an electrode of the prior art with the membrane 8. The first layer 3 and/or the second layer 5 may thus be formed by a mesh with less regular unit cells than the existing meshes and/or may be irregular.

The first layer 3 and/or the second layer 5 may thus be formed by a mesh composed over at least one zone (and optionally over the entire first layer 3 and/or second layer 5) of at least one pattern that repeats along at least one direction in space and preferably at least two mutually orthogonal directions in space, and optionally along three mutually orthogonal directions in space. The pattern may be a geometrical pattern, for example a polygonal pattern (square, hexagon, etc.) or a circular patterns repeat(s) at least in a plane of the layer in question, which plane is orthogonal to the thickness of said layer (the thickness of the layer being its smallest dimension).

Of course, the invention is not limited to the embodiment described, but includes any variant that falls within the field of the invention as defined by the claims.

In particular, although the bipolar plate 1 is not manufactured here by additive manufacturing, the bipolar plate 1 may also be manufactured by additive manufacturing. In this case, the bipolar plate 1 may be manufactured entirely during a first step by additive manufacturing (the layers then being printed on its faces) or it may be manufactured partially on only one side so as to finish the printing of the first layer 3 first, before continuing to print the bipolar plate 1 then the second layer 5. As a variant, one of the layers 3, 5 may be the one 3 printed first, followed by the bipolar plate 1 and the second 5 of the two layers 3, 5. Other printing sequences are of course possible. The bipolar plate 1 may optionally then be printed from the same material as at least one of the layers 3, 5 or from another material.

At least the first layer 3 or the second layer 5 may be printed from at least two different materials.

A single layer 3 or 5 may be printed on the bipolar plate 1.

One or more gaskets may also be arranged between two aforementioned assemblies 7.

The aforementioned assemblies 7 may be fixed in pairs or may be fixed by tie rods that pass through the entire block 11 of electrolytic cells. The bipolar plates 1 and/or the layers 3, 5 will, for example, be configured to comprise one or more orifices by which they are fastened within the electrolyzer stack.

The second layer 5 may be non-identical to the first layer 3 in terms of material and/or shape.

Although the bipolar plate 1 as well as its two layers 3, 5 are based on nickel here, at least one zone of the bipolar plate 1 and/or of at least one of the layers 3 or 5 may consist of another material. In particular, at least one of the layers may be printed from a material based on a substance other than nickel, and may for example be printed from a material based on chromium, iron, etc.

The cellular structure may have a shape other than that indicated. For example, the structure may contain at least one zone without a repeating pattern and/or may have at least one non-uniform zone. In the event that there is a pattern, it may be non-geometrical and/or non-polygonal.

1. A method for manufacturing at least a part of an electrolytic cell, the method comprising at least printing at least one layer (3) on a first face of a bipolar plate (1) by additive manufacturing, of which layer a first face (4a) is secured to the first face of the bipolar plate (1) and the second face (4b) forms at least one free end, the layer being formed by a mesh describing a cellular structure, the contact between the first face and the first main face (2a) being formed by a plurality of point contacts between said layer (3) and the first main face.

2. The method as claimed in claim 1, wherein the bipolar plate (1) is also manufactured by an additive method.

3. The method as claimed in claim 1, wherein the layer (3) and/or the bipolar plate (1) is printed from a nickel-based material.

4. The method as claimed in claim 1 wherein the layer (3) is a first layer, the method further comprising printing at least one second layer (5) on a second face of the bipolar plate (1) by additive manufacturing, of which layer a first face is secured to the second face of the bipolar plate (1) and the second face forms at least one free end, the second layer (5) being formed by a mesh describing a cellular structure.

5. The method as claimed in claim 4, wherein the first layer (3) has the same shape as the second layer (5).

6. The method as claimed in claim 4, wherein the second layer (5) consists of the same material as the first layer (3).

7. The method as claimed in claim 4, wherein the two layers (3, 5) are printed at the same time.

8. The method as claimed in claim 1, wherein the bipolar plate (1) is a first bipolar plate, the method further comprising printing at least one layer on a first face of a second bipolar plate by additive manufacturing, of which layer a first face is secured to the first face of the bipolar plate and the second face forms at least one free end, the layer being formed by a mesh describing a cellular structure.

9. The method as claimed in claim 8, wherein the two bipolar plates (1) are contiguous while being separated by a membrane (8), so that the second faces of the layers of the two bipolar plates (1) both lie next to the membrane (8).

10. A part of an electrolytic cell, which is manufactured by a method as claimed in claim 1.

11. An electrolyzer stack comprising a cell part as claimed in claim 10.

12. The method as claimed in claim 2, wherein the layer (3) is a first layer, the method further comprising printing at least one second layer (5) on a second face of the bipolar plate (1) by additive manufacturing, of which layer a first face is secured to the second face of the bipolar plate (1) and the second face forms at least one free end, the second layer (5) being formed by a mesh describing a cellular structure.

13. The method as claimed in claim 12, wherein the first layer (3) has the same shape as the second layer (5).

14. The method as claimed in claim 3, wherein the layer (3) is a first layer, the method further comprising printing at least one second layer (5) on a second face of the bipolar plate (1) by additive manufacturing, of which layer a first face is secured to the second face of the bipolar plate (1) and the second face forms at least one free end, the second layer (5) being formed by a mesh describing a cellular structure.

15. The method as claimed in claim 12, wherein the first layer (3) has the same shape as the second layer (5).
